(19) United States
(12) Patent Application Publication
(10) Pub. No.: US 2009/0273420 A1
(43) Pub. Date: Nov. 5, 2009

(54) ELECTROMAGNETIC SWITCH

(75) Inventors: An Dan Trinh, Orange, CA (US); Kiem Cong Trinh, Cypress, CA (US)

Correspondence Address: K&L GATES LLP, 535 SMITHFIELD STREET, PITTSBURGH, PA, 15222, US

(73) Assignee: Teledyne Technologies Incorporated, Thousand Oaks, CA (US)

(21) Appl. No.: 12/115,304

(22) Filed: May 5, 2008

(51) Int. Cl. H01H 9/00

(52) U.S. Cl. 335/177

(57) ABSTRACT

An electromechanical switch may be actuated in a plurality of modes. A base portion of the electromechanical switch includes first and second electrical ports adapted to be electrically coupled in a plurality of modes. A first electromagnetic coil defines a longitudinal axis and is adapted to receive a first energizing current. A second electromagnetic coil extends along the longitudinal axis in spaced apart relationship with the first electromagnetic coil. The second electromagnetic coil is adapted to receive a second energizing current. The first and second ports are selectively coupled in any one of open-terminated mode, attenuation mode, and a short circuit mode based on the energy state of the first and second electromagnetic coils.

### BACKGROUND

The present disclosure is directed generally to electromagnetic switches.

Electromagnetic switches are employed in modern electronic test equipment such as digital signal oscilloscopes, spectrum analyzers, data analyzers, and vector analyzers, for example. Modern electronic test equipment, such as microwave signal analyzers, operate at broadband frequencies from direct current (DC) up into the gigahertz (GHz) range. Such broadband electronic test equipment requires multi-mode switching devices to direct microwave (e.g., millimeter wave) signals with minimum loss, to attenuate incoming signals hundreds of times below their original power level before processing, and to interrupt input signals with minimum crosstalk during system calibration cycles. Each of these tasks requires a complex setup of switching devices. Accordingly, there is a need for an electromagnetic switch that may be actuated in various modes to satisfy complex switching functions.

### SUMMARY

In one embodiment an electromagnetic switch comprises first and second ports adapted to receive an electrical signal. A first solenoid defines a longitudinal axis. The first solenoid is adapted to receive a first energizing current. A second solenoid is positioned along the longitudinal axis. The second solenoid is adapted to receive a second energizing current. The first and second solenoids are adapted to selectively engage first, second, and third electrical contact elements to selectively couple the first and second ports to an impedance element based on the energy state of the first and second solenoids.

### BRIEF DESCRIPTION OF THE DRAWINGS

FIG. 1 is a partial cross-sectional view of one embodiment of an electromagnetic switch comprising first and second electromagnetic coils in a de-energized state connecting first and second input/output interface ports in open-terminated mode.

FIG. 2 is a partial cross-sectional view of one embodiment of the electromagnetic switch shown in FIG. 1 with the first electromagnetic coil in a de-energized state and the second electromagnetic coil in an energized state connecting the first and second input/output interface ports in attenuated mode.

FIG. 3 is a partial cross-sectional view of one embodiment of the electromagnetic switch shown in FIG. 1 with the first electromagnetic coil in an energized state and the second electromagnetic coil in a de-energized state connecting the first and second input/output interface ports in through mode.

FIG. 4 is a partial cross-sectional front view of the base portion of one embodiment of the electromagnetic switch shown in FIG. 1.

FIG. 5 is a partial cross-sectional side view of the base portion of one embodiment of the electromagnetic switch shown in FIG. 1.

FIG. 6 is a partial cross-sectional rear view of the base portion of one embodiment of the electromagnetic switch shown in FIG. 1.

FIG. 7 is a circuit schematic diagram of one embodiment of the electromagnetic switch shown in FIG. 1 in open-terminated mode.

FIG. 8 is a circuit schematic diagram of one embodiment of the electromagnetic switch shown in FIG. 1 in attenuated mode.

FIG. 9 is a circuit schematic diagram of one embodiment of the electromagnetic switch shown in FIG. 1 in through mode.

FIG. 10 is a diagram to illustrate the operation of one embodiment of the electromagnetic switch shown in FIG. 1 in open-terminated mode.

FIG. 11 is a diagram to illustrate the operation of one embodiment of the electromagnetic switch 100 shown in FIG. 1 in attenuated mode.

FIG. 12 is a diagram to illustrate the operation of one embodiment of the electromagnetic switch 100 shown in FIG. 1 in through mode.

### DESCRIPTION

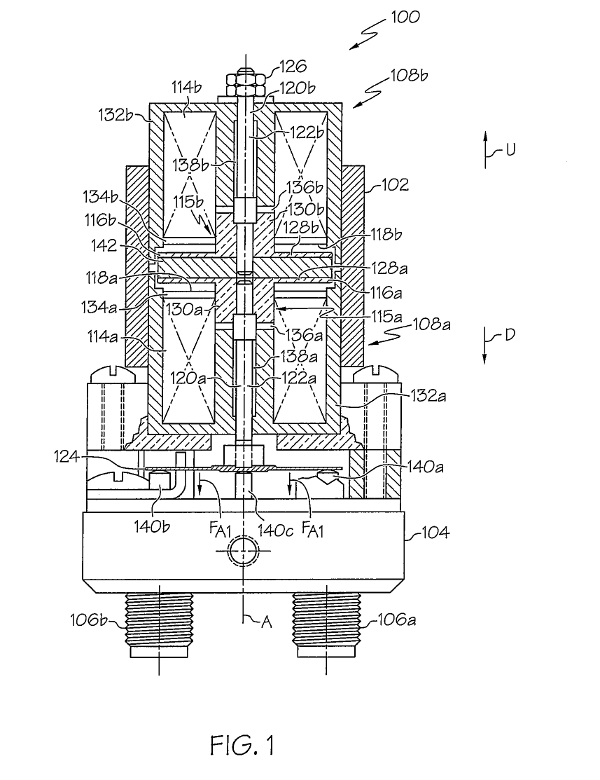

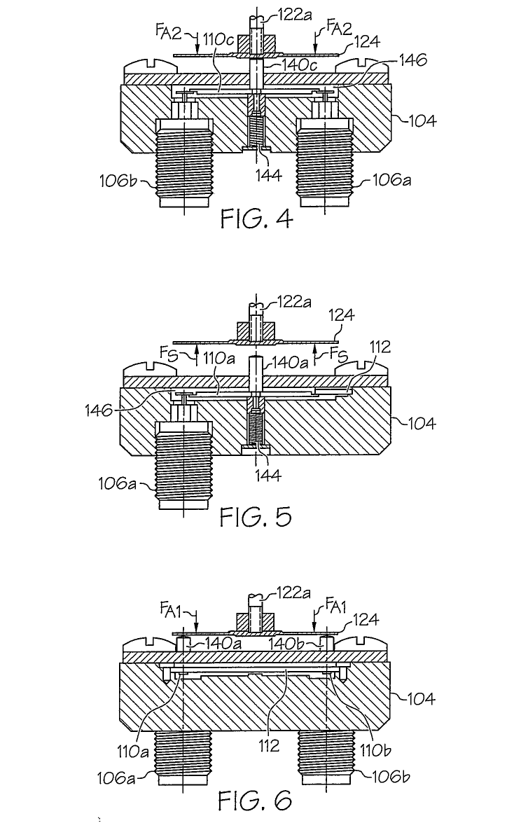

FIG. 1 is a partial cross-sectional view of one embodiment of an electromagnetic switch 100. FIG. 4 is a partial cross-sectional front view of the base portion of one embodiment of the electromagnetic switch 100 shown in FIG. 1. FIG. 5 is a partial cross-sectional side view of the base portion of one embodiment of the electromagnetic switch 100 shown in FIG. 1. FIG. 6 is a partial cross-sectional rear view of the base portion of one embodiment of the electromagnetic switch 100 shown in FIG. 1. With reference to FIGS. 1 and 4-6, in one embodiment, the electromagnetic switch 100 comprises a housing 102 including a radio frequency (RF) base portion 104 comprising a first input/output interface port 106a and a second input/output interface port 106b. The electromagnetic switch 100 also comprises a first solenoid 108a and a second solenoid 108b, three electrical contact elements 110a, 110b, 110c (FIGS. 4-6) and an impedance element 112 (FIG. 5). In one embodiment, the first and second input/output interface ports 106a, b may be coaxial RF connectors such as subminiature version A (SMA) connectors. In one embodiment, the first and second input/output interface ports 106a, b may be implemented as jack type versions of the SMA RF connectors. The first, second, and third electrical contact elements 110a-c can selectively switch microwave signals from DC to about 25 GHz between the input/output interface ports 106a, b in three different modes: open-terminated mode, attenuated mode, and through mode based on the energy state of the first and second solenoids 108a, b.

The first solenoid 108a defines a longitudinal axis “A” and is adapted to receive a first energizing current. The second solenoid 108b is positioned along the longitudinal axis “A” and is adapted to receive a second energizing current. The first and second solenoids 108a, b are adapted to engage the first, second, and third electrical contact elements 110a-c (FIGS. 4-6). The impedance element 112 (FIG. 5) may be selectively coupled between the first and second input/output interface ports 106a, b based on the energy state of the first and second solenoids 108a, b.

In one embodiment, the first solenoid 108a comprises a first electromagnetic coil 114a, a first ferromagnetic core 132a, a first armature 115a, and a first piston 120a. The first electromagnetic coil 114a is positioned along the longitudinal axis “A” and is adapted to receive the first energizing current. The first ferromagnetic core 132a comprises a first opening 134a adapted to fixedly receive the first electromagnetic coil 114a therein. The first ferromagnetic core 132a also comprises a second opening 136a and a third opening 138a extending along the longitudinal axis “A.” The first armature 115a is movable along the longitudinal axis “A” relative to the first electromagnetic coil 114a. When the first electromagnetic coil 114a is energized, the first armature 115a moves to a first stroke end position 118a. The first armature 115a comprises a first ferromagnetic element 116a comprising an axial portion 130a extending along the longitudinal axis “A” and a radial portion 128a to engage a first surface at the first stroke end position 118a. The axial portion 130a is slidably receivable within the second opening 136a of the first ferromagnetic core 132a. The first piston 120a extends along the longitudinal axis “A” and is coupled to the first armature 115a. The first piston 120a comprises a first rod 122a having a first end and a second end and an actuator member 124 extending substantially perpendicular from the longitudinal axis “A.” The first end of the first rod 122a is attached to the actuator member 124. The second end of the first rod 122a is attached to the axial portion 130a of the first ferromagnetic element 116a. A portion of the first rod 122a is slidably receivable within the third opening 138a of the first ferromagnetic core 132a.

The actuator member 124 is adapted to selectively engage the first, second, and third electrical contact elements 110a-c (FIGS. 4-6) based on the energy state of the first and second solenoids 108a, b. First, second, and third dielectric carriers 140a, 140b, 140c each comprise a first end adapted to engage the respective first, second, and third electrical contact elements 110a-c and a second end adapted to be engaged by the actuator member 124. The actuator member 124 applies a force F_{A1} to the second end of the first, second, and third dielectric carriers 140a-c. Each of the first, second, and third dielectric carriers 140a-c selectively transfer the actuation force imparted by the actuator member 124 to the respective first, second, and third electrical contact elements 110a-c based on the energy state of the first and second electromagnetic coils 114a, b.

In one embodiment, a cavity 146 is formed within the base portion 104 to house the first, second, and third electrical contact elements 110a-c, the corresponding portions of the first, second, and third dielectric carriers 140a-c, and the impedance element 112 (FIG. 5). In one embodiment, the body portion 104 is a square aluminum housing with sides having a length of 1.2 inches. In one embodiment, the first and second electrical contact elements 110a, 110b are vertically oriented within the cavity 146. The vertically oriented first and second electrical contact elements 110a, b are reeds positioned in a lower configuration. The first electrical contact element 110a has a length of about 0.6 inches and a height of about 0.3 inches. The first dielectric carrier 140a has a diameter of about 0.07 inches and is located at the center of the first electrical contact element 110a. The second electrical contact element 110b has a length of about 0.6 inches and a height of about 0.315 inches. The second dielectric carrier 140a has a diameter of about 0.07 inches and is located at the center of the second electrical contact element 110b. The third electrical contact element 110c is positioned in an upper configuration and horizontally oriented within the cavity 146. In one embodiment, the horizontal electrical contact element 110c comprises a reed having a length of about 0.6 inches, a height of about 0.3 inches, and the dielectric carrier 140c having a diameter of about 0.07 inches diameter located at its center. The physical characteristics of the third electrical contact element are similar to the first electrical contact element 110a.

In one embodiment, the second solenoid 108b comprises a second electromagnetic coil 114b, a second ferromagnetic core 132b, a second armature 115b, and a second piston 120b. The second electromagnetic coil 114b extends along the longitudinal axis “A” in spaced apart relationship with the first electromagnetic coil 108a and is adapted to receive the first energizing current. The second ferromagnetic core 132b comprises a first opening 134b adapted to fixedly receive the second electromagnetic coil 114b and a second opening 136b and a third opening 138b, each extending along the longitudinal axis “A.” The second armature 115b is movable along the longitudinal axis “A” relative to the second electromagnetic coil 114b to a second stroke end position 118b when the second electromagnetic coil 114b is energized. The second armature 115b comprises a second ferromagnetic element 116b comprising an axial portion 130b extending along the longitudinal axis “A” and a radial portion 128b to engage a second surface at the second stroke end position 118b. The second armature 115b is separated from the first armature 115a by a magnetic isolator element 142. For conciseness and clarity, the combination of the first and second armatures 115a, b may be referred to as the armature or movable armature, and the combination of the first and second armatures 115a, b and the magnetic isolator element 142 also may be referred to as the armature or movable armature, without departing from the scope of the embodiment. The axial portion 130b is slidably receivable within the second opening 136b of the second ferromagnetic core 132b. The second piston 120b extends along the longitudinal axis “A” and is coupled to the first armature 115a. The second piston 120b comprises a second rod 122b having a first end and a second end. The first end of the second rod 122b is attached to a stroke limit element 126. The second end of the second rod 122b is attached to the axial portion 130b of the second ferromagnetic element 116b. A portion of the second rod 122b is slidably receivable within the third opening 138b of the second ferromagnetic core 132b.

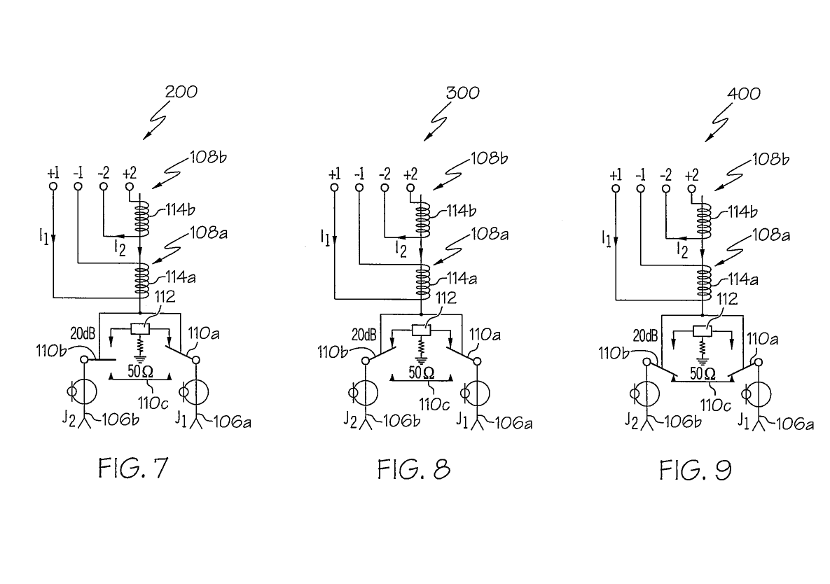

In operation, the electromagnetic switch 100 is actuated by driving the first and second solenoids 108a, b in a predetermined manner. The first and second solenoids 108a, b are positioned in tandem and reverse acting as shown in FIGS. 1-3 with the second solenoid 108b positioned above the first solenoid 108a. The first and second electromagnetic coils 114a, b may be driven with energizing currents (e.g., I₁ and I₂ FIGS. 7-9) and thus are actuated in opposite directions. The first piston 120a of the first solenoid 108a is driven in the direction indicated by arrow “D” when a first energizing current is applied to the first electromagnetic coil 114a. The second piston 120b of the second solenoid 108b is driven in the direction indicated by arrow “U” when a second energizing current is applied to the second electromagnetic coil 114b.

As shown in FIG. 1, the first and second electromagnetic coils 114a, b are both in a de-energized state with no energizing current applied thereto. The armatures 115a, b are positioned between the first stroke end position 118a and the second stroke end position 118b. The first electrical contact element 110a is coupled to the impedance element 112 and the first port 106a. The second electrical contact element 110b is decoupled from the impedance element 112 and the second port 106b. In this energy state, the second piston 120b partially pushes on the first end of the first piston 120a. The actuator member 124 engages the second end of the second dielectric carrier 140b and applies force F_{A1} thereto in direction “D.” The force is sufficient to create a small gap and electrically open the second electrical contact element 110b. The force F_{A1} is not sufficient for the actuator member 124 to engage the second end of the first and third dielectric carriers 140a, c because the height of the first and third dielectric carriers 140a, c is shorter than the height of the second dielectric carrier 140b. The impedance element 112 presents a shunt resistance with a 50 Ohm termination effect to the first input/output interface port 106a. This mode may be referred to as “open-terminated mode” or simply as “open” mode. Accordingly, the first and second input/output interface ports 106a, b are selectively coupled in open-terminated mode.

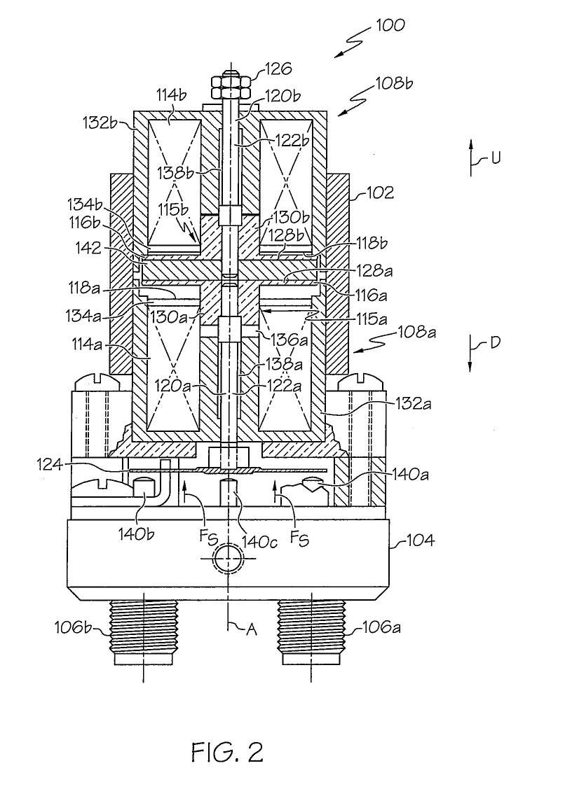

FIG. 2 is a partial cross-sectional view of one embodiment of the electromagnetic switch 100 shown in FIG. 1 with the first electromagnetic coil 114a in a de-energized state and the second electromagnetic coil 114b in an energized state. In this energy state, the second armature 115b is positioned at the second stroke end position 118b. The first and second electrical contact elements 110a, b are coupled to the impedance element 112. In one embodiment, the impedance element 112 provides 20 dB of attenuation. When the second electromagnetic coil 114b is energized, both the first and second pistons 120a, b retract in direction “U” and the actuator member 124 disengages the second ends of the first, second, and third dielectric carriers 140a-c. The first, second, and third electrical contact elements 110a-c return to their unloaded position by a force F_{S} applied by a spring 144 (FIG. 5) in direction “U.” The first and second electrical contact elements 110a, b are coupled to the impedance element 112. Accordingly, the first and second input/output interface ports 106a, b are selectively coupled in attenuated mode. This mode may be referred to as an “attenuated path” or “high loss path” by those skilled in the art.

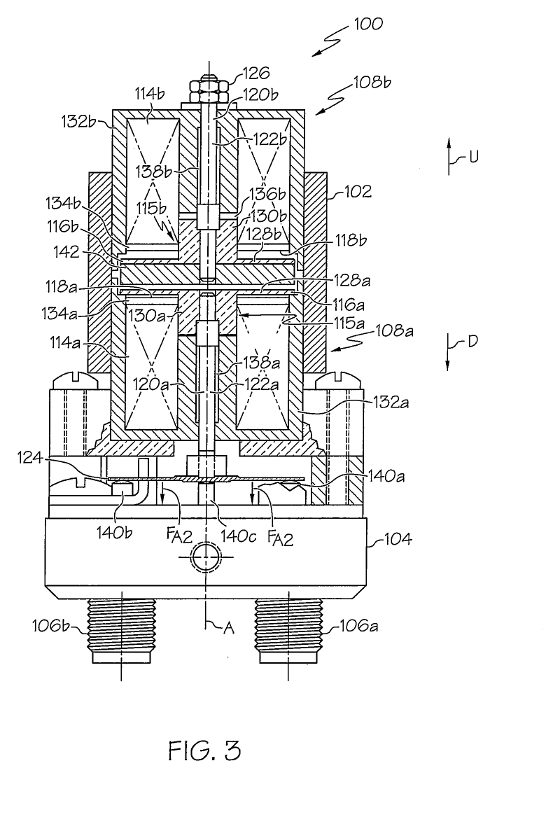

FIG. 3 is a partial cross-sectional view of one embodiment of the electromagnetic switch 100 shown in FIG. 1 with the first electromagnetic coil 114a in an energized state and the second electromagnetic coil 114b in a de-energized state. In this energy state, the armature 115a is positioned at the first stroke end position 118a and the first and second electrical contact elements 110a, b are coupled to the third electrical contact element 110c. When the first electromagnetic coil 114a is energized and the second electromagnetic coil 114b is de-energized, the first piston 120a moves in direction “D” and the actuator member 124 engages the first end of the first, second, and third dielectric carriers 140a-c. The actuator member 124 applies a suitable force F_{A2} such that the first and second electrical contact elements 110a, b couple to the third electrical contact element 110c. The first and second input/output interface ports 106a, b are coupled to the third electrical contact element 110c. Accordingly, the first and second input/output interface ports 106a, b are selectively coupled in through mode. This mode may be referred to as a “through path,” “zero loss path,” or “short circuit path” by those skilled in the art.

FIGS. 7-9 are circuit schematic diagrams 200, 300, 400 of one embodiment of the electromagnetic switch 100 shown in FIG. 1 in respective open-terminated mode, attenuated mode, and through mode. Signals from DC to RF frequencies (e.g., 0 to about 25 GHZ) are received at either the first input/output interface port 106a or the second input/output interface port 106b. A first energizing current I₁ may be applied to the first solenoid 108a via input terminals +1 and −1. The first energizing current I₁ is driven through the first electromagnetic coil 114a. A second energizing current I₂ may be applied to the second solenoid 108b via input terminals +2 and −2. The second energizing current I₂ is driven through the second electromagnetic coil 114b.

FIG. 7 is a circuit schematic diagram 200 of the electromagnetic switch 100 in “open-terminated mode.” No energizing current is applied to the first and second electromagnetic coils 114a, b and thus the first and second electromagnetic coils 114a, b are both de-energized. Thus, I₁ and I₂ are both zero. In this energy state, the first electrical contact element 110a is coupled to the impedance element 112 and the first input/output interface port 106a. The second electrical contact element 111b is decoupled from the impedance element 112 and the second input/output interface port 106b. The impedance element 112 presents a shunt resistance with a 50 Ohm termination effect to the first input/output interface port 106a. Accordingly, the first and second input/output interface ports 106a, b are selectively coupled in open-terminated mode.

FIG. 8 is a circuit schematic diagram 300 of one embodiment of the electromagnetic switch 100 shown in FIG. 1 in attenuated mode. The first electromagnetic coil 114a is de-energized with I₁ being zero and the second electromagnetic coil 114b is energized with I₂ being non-zero. In this energy state, the first and second electrical contact elements 10a, b are coupled to the impedance element 112. In one embodiment, the impedance element 112 provides 20 dB of attenuation. Accordingly, the first and second input/output interface ports 106a, b are selectively coupled in attenuation mode.

FIG. 9 is a circuit schematic diagram 400 of one embodiment of the electromagnetic switch 100 shown in FIG. 1 in through mode. The first electromagnetic coil 114a is energized with I₁ being non-zero and the second electromagnetic coil 114b is de-energized with I₂ being zero. In this energy state, the first and second electrical contact elements 110a, b are coupled to the third electrical contact element 110c. Accordingly, the first and second ports 106a, b are selectively coupled in the short circuit mode.

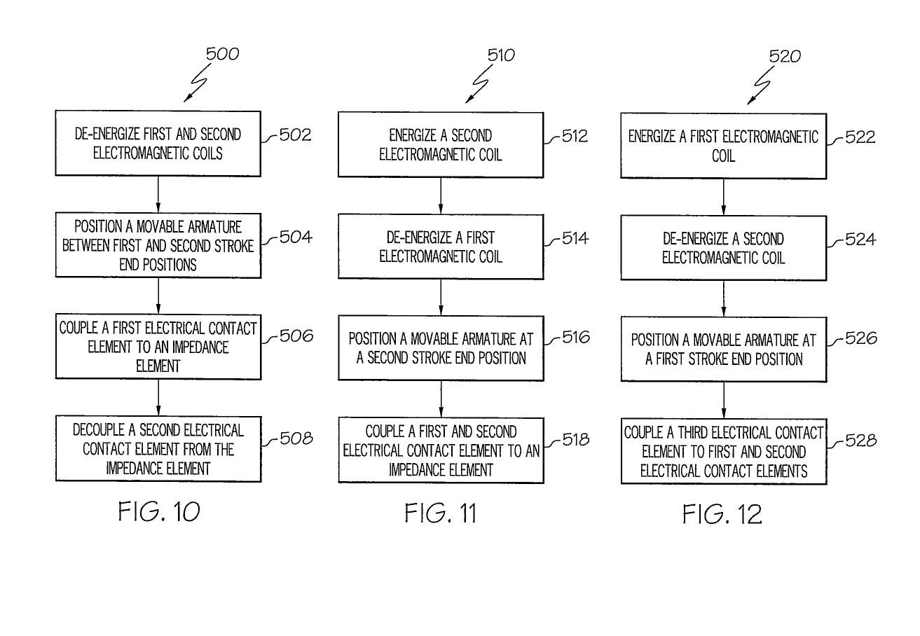

FIG. 10 is a diagram 500 to illustrate the operation of one embodiment of the electromagnetic switch 100 shown in FIG. 1 in open-terminated mode. Accordingly, the first and second electromagnetic coils 114a, b are de-energized 502 to position 504 the movable armature 115a, b between the first stroke end position 118a and the second stroke end position 118b in response to de-energizing the first and second electromagnetic coils 114a, b. The first electrical contact element 110a is coupled 506 to the impedance element 112. The second electrical contact element 110b is decoupled 508 from the impedance element 112.

FIG. 11 is a diagram 510 to illustrate the operation of one embodiment of the electromagnetic switch 100 shown in FIG. 1 in attenuated mode. Accordingly, the second electromagnetic coil 114b is energized 512 and the first electromagnetic 114a coil is de-energized 514. The movable armature 115b is positioned 516 at the second stroke end position 118b. The first and second electrical contact elements 110a, b are coupled 518 to the impedance element 112.

FIG. 12 is a diagram 520 to illustrate the operation of one embodiment of the electromagnetic switch 100 shown in FIG. 1 in through mode. Accordingly, the first electromagnetic coil 114a is energized 522 and the second electromagnetic 114b coil is de-energized 524. The movable armature 118a is positioned 526 at the first stroke end position 118a. The third electrical contact element 110c is coupled 528 to the first and second electrical contact elements 110a, b.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true scope of the embodiments.

1. An electromechanical switch, comprising:
a base portion comprising first and second electrical ports adapted to be electrically coupled in a plurality of modes;
a first electromagnetic coil defining a longitudinal axis and adapted to receive a first energizing current;
a second electromagnetic coil extending along the longitudinal axis in spaced apart relationship with the first electromagnetic coil, the second electromagnetic coil adapted to receive a second energizing current;
wherein the first and second ports are selectively coupled in any one of open-terminated mode, attenuation mode, and a short circuit mode based on the energy state of the first and second electromagnetic coils.

2. The electromagnetic switch of claim 1, comprising:
an armature movable along the longitudinal axis relative to the first and second electromagnetic coils between a first stroke end position and a second stroke end position;
a piston extending along the longitudinal axis coupled to the armature, the piston comprising a first rod having a first end and a second end and an actuator member extending substantially perpendicular from the longitudinal axis attached to the first end of the first rod;
a first electrical contact element coupled to the first electrical port, the first electrical contact element is moveable from a first position to at least a second position in response to a force applied by the actuator member; and
a second electrical contact element coupled to the second electrical port, the second electrical contact element is moveable from a first position to at least a second position in response to a force applied by the actuator member.

3. The electromagnetic switch of claim 2, wherein, when the first and second electromagnetic coils are de-energized, the armature is positioned between the first stroke end position and the second stroke end position, the first electrical contact element is coupled to an impedance element, the second electrical contact element is decoupled from the impedance element, and the first and second ports are selectively coupled in the open-terminated mode.

4. The electromagnetic switch of claim 2, wherein, when the second electromagnetic coil is energized and the first electromagnetic coil is de-energized, the armature is positioned at the second stroke end position, the first and second electrical contact elements are coupled to the impedance element, and the first and second ports are selectively coupled in the attenuation mode.

5. The electromagnetic switch of claim 2, wherein, when the first electromagnetic coil is energized and the second electromagnetic coil is de-energized, the armature is positioned at the first stroke end position, the first and second electrical contact elements are coupled to a third electrical contact element, and the first and second ports are selectively coupled in the short circuit mode.

6. The electromagnetic switch of claim 2, comprising:
first, second, and third dielectric carriers, each comprising a first end adapted to engage the respective first, second, and third electrical contact elements and a second end adapted to be engaged by the actuator member, each of the first, second, and third dielectric carriers selectively transfer an actuation force imparted by the actuator member to the first, second, and third electrical contact elements based on the energy state of the first and second electromagnetic coils.

7. The electromagnetic switch of claim 6, wherein, when the first and second electromagnetic coils are de-energized, the actuator member engages the second end of the second dielectric carrier to decouple the second electrical contact element from the second port and disengages the second ends of the first and third dielectric carriers to selectively couple the first electrical contact element to the impedance element and the first port.

8. The electromagnetic switch of claim 6, wherein, when the first electromagnetic coil is de-energized and the second electromagnetic coil is energized, the actuator member disengages the second ends of the first, second, and third dielectric carriers to selectively couple the first and second ports to an impedance element.

9. The electromagnetic switch of claim 6, wherein, when the first electromagnetic coil is energized and the second electromagnetic coil is de-energized, the actuator member engages the second ends of the first, second, and third dielectric carriers to selectively couple the first and second ports to the third electrical contact element.

10. The electromagnetic switch of claim 2, wherein the armature comprises:
a first ferromagnetic element comprising an axial portion extending along the longitudinal axis and a radial portion extending substantially perpendicular to the longitudinal axis to engage a first surface at the first stroke end position, the axial portion of the first ferromagnetic element is attached to the second end of the first rod;
a second ferromagnetic element comprising an axial portion extending along the longitudinal axis and a radial portion extending substantially perpendicular to the longitudinal axis to engage a second surface at the second stroke end position;
a second rod having a first end and a second end extending along the longitudinal axis, the first end of the second rod is attached to a stroke limit element, the axial portion of the second ferromagnetic element is attached to the second end of the second rod; and
a magnetic isolator element located between the first and second ferromagnetic elements.

11. The electromagnetic switch of claim 10, comprising:
a first ferromagnetic core defining a first opening adapted to fixedly receive the first electromagnetic coil; and
a second ferromagnetic core comprising a second opening adapted to fixedly receive the second electromagnetic coil.

12. The electromagnetic switch of claim 11, wherein the first ferromagnetic core comprises:
a second opening extending along the longitudinal axis to slidably receive the axial portion of the first ferromagnetic element; and
a third opening extending along the longitudinal axis to slidably receive a portion of the first rod.

13. The electromagnetic switch of claim 11, wherein the second ferromagnetic core comprises:
a second opening extending along the longitudinal axis to slidably receive the axial portion of the second ferromagnetic element; and
a third opening extending along the longitudinal axis to slidably receive a portion of the second rod.

14. The electromagnetic switch of claim 2, comprising a spring to engage the third electrical contact member.

15. An electromechanical switch, comprising:
first and second ports adapted to receive an electrical signal;
a first solenoid defining a longitudinal axis adapted to receive a first energizing current;
a second solenoid positioned along the longitudinal axis adapted to receive a second energizing current;
the first and second solenoids are adapted to selectively engage first, second, and third electrical contact elements to selectively couple the first and second ports to an impedance element based on the energy state of the first and second solenoids.

16. The electromechanical switch of claim 15, wherein the first solenoid comprises:
a first electromagnetic coil positioned along the longitudinal axis and adapted to receive the first energizing current;
a first armature movable along the longitudinal axis relative to the first electromagnetic coil to a first stroke end position when the first electromagnetic coil is energized; and
a piston extending along the longitudinal axis coupled to the first armature, the piston comprising a first rod having a first end and a second end and an actuator member extending substantially perpendicular from the longitudinal axis attached to the first end of the first rod, the actuator member is adapted to selectively engage the first, second, and third electrical contact elements.

17. The electromechanical switch of claim 15, wherein the second solenoid comprises:
a second electromagnetic coil positioned along the longitudinal axis and adapted to receive the second energizing current;
a second armature movable along the longitudinal axis relative to the second electromagnetic coil to a second stroke end position when the second electromagnetic coil is energized; and
a second rod having a first end and a second end extending along the longitudinal axis, the first end of the second rod is attached to a stroke limit element.

18. The electromagnetic switch of claim 15, wherein the first, second, and third electrical contact elements are selectively coupled to any one of an open circuit, an attenuation circuit, and a short circuit based on the energy state of the first and second solenoids.

19. A method of switching a circuit using an electromagnetic switch, the method comprising:
de-energizing first and second electromagnetic coils;
positioning a movable armature between a first stroke end position and a second stroke end position in response to de-energizing the first and second electromagnetic coils;
coupling a first electrical contact element to an impedance element; and
decoupling a second electrical contact element from the impedance element.

20. The method of claim 19, comprising:
energizing the second electromagnetic coil;
positioning the movable armature at the second stroke end position; and
coupling the first and second electrical contact elements to the impedance element.

21. The method of claim 19, comprising:
energizing the first electromagnetic coil;
positioning the movable armature at the first stroke end position;
coupling a third electrical contact element to the first and second electrical contact elements.
